(19) United States
(12) Patent Application Publication
(10) Pub. No.: US 2002/0011368 A1
(43) Pub. Date: Jan. 31, 2002

(54) Self-propelled drive wheel

(75) Inventor: Karel van den Berg, Bleskensgraaf (NL)

Correspondence Address: MASON, MASON & ALBRIGHT, 2306 South Eads Street, P.O. Box 2246, Arlington, VA, 22202, US

(73) Assignee: LELY RESEARCH HOLDING A.G., a Swiss Limited Liability Company

(21) Appl. No.: 09/883,917

(22) Filed: Jun. 20, 2001

Related U.S. Application Data
(63) Continuation of application No. PCT/NL00/00665, filed on Sep. 19, 2000.

(30) Foreign Application Priority Data
Oct. 20, 1999 (NL) 1013353

(51) Int. Cl. B62D 61/00; B62D 11/00; B60K 1/00

(52) U.S. Cl. 180/218; 180/6.5; 180/65.5

(57) ABSTRACT

With a vehicle comprising a motor (5) and at least one rotatable element (1, 2; 10) which follows the ground, at least one rotatable element (1, 2; 10) is connected to a steering mechanism for controlling the direction of travel of the vehicle. The steering mechanism comprises means (11) for adjusting the momentary distance from the axis of rotation of at least a part of a rotatable element (1, 2; 1 0) to the ground or means for adjusting the momentary coefficient of friction of at least a part of a rotatable element (1, 2; 10). Thus, the vehicle has a simple steering mechanism.

The invention relates to a vehicle according to the preamble of claim 1. Vehicles are generally known in many different designs.

The invention aims at providing a vehicle with a simple steering mechanism. According to the invention this is achieved by the measures mentioned in the characterizing part of claim 1 or by the measures mentioned in the characterizing part of claim 5.

The invention will now be explained in further detail with reference to the accompanying drawings.

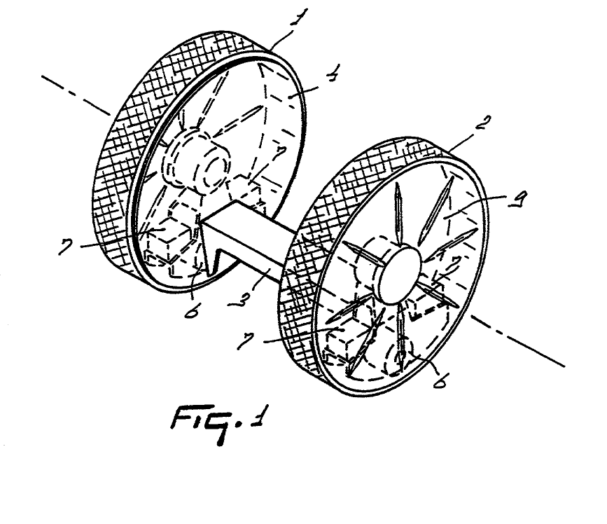

FIG. 1 is a schematic perspective view of an embodiment of a vehicle according to the invention;

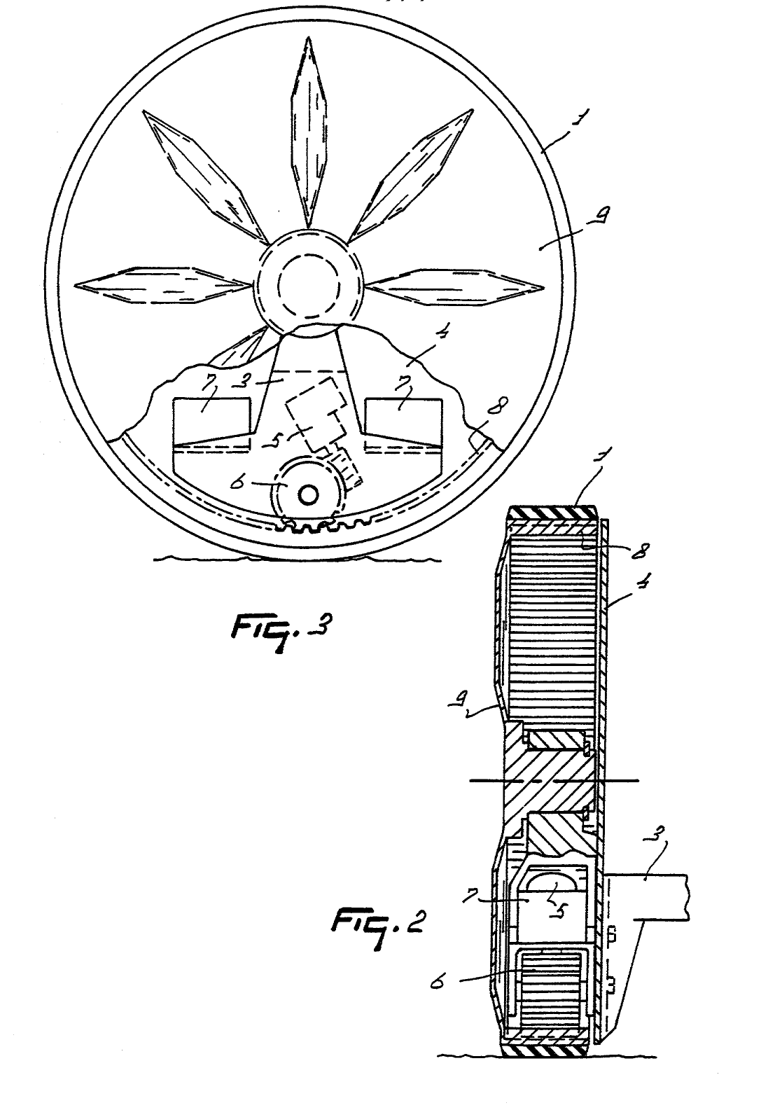

FIG. 2 is a schematic cross-section of a part of the vehicle depicted in FIG. 1;

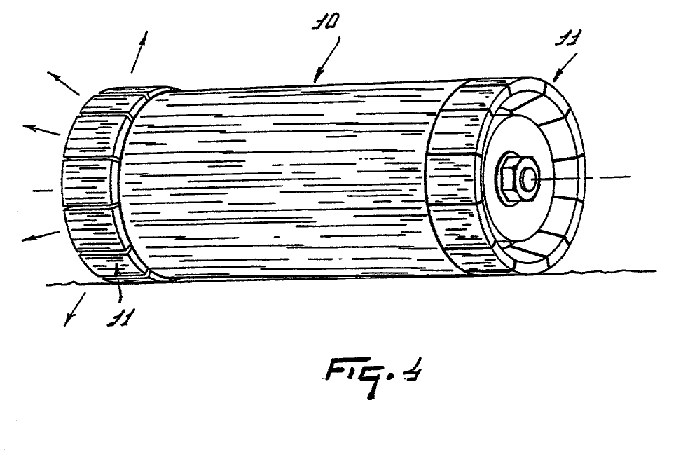

FIG. 3 is a schematic side view of the vehicle according to the arrow in FIG. 2, and

FIG. 4 is a schematic perspective view of a further embodiment of a vehicle according to the invention.

FIGS. 1, 2 and 3 show schematically a perspective view, a cross-section and a side view, respectively, of a first embodiment of a vehicle according to the invention. The vehicle. comprises two wheels 1, 2 which are interconnected by means of a frame 3. The middle piece of the frame 3 is connected on both sides to a cover disc 4 (see FIG. 2), which disc 4 is disposed along the inner side of the associated wheel 1, 2 but is not connected to said wheel 1, 2. Each disc 4 is connected itself to a drive unit disposed in the associated wheel 1, 2, which drive unit comprises a motor 5, a drive wheel 6 and accumulators 7 (see FIGS. 2 and 3). Each drive unit may further be made heavier, if desired, by providing it with an extra weight. Each of the motors 5 is suitable for driving, e.g. with the aid of a worm wheel construction, the associated drive wheel 6 which is provided with teeth that co-operate with a toothing 8 on the inner side of the associated wheel 1, 2.

The drive unit which is connected to the frame 3 is freely rotatably suspended, via bearings, from the axis of the associated wheel 1, 2. Said suspension from the physical axis of rotation of the wheel 1, 2 provides a solid construction. The drive wheel 6 driven by the motor 5 ensures that the drive unit loses its position of equilibrium, so that the centre of gravity of the vehicle is displaced and the wheels 1, 2 are put into rotation by the effect of gravitational force. The vehicle will tend to lower its centre of gravity. However, the motor 5 continuously raises the centre of gravity of the vehicle, so that the wheels 1, 2 continue to rotate and the vehicle moves forward in a substantially straight line.

The motors 5 are capable of co-operating for driving the two wheels 1, 2. When the sense of rotation of one of the motors 5 is reversed, the wheels 1, 2 will rotate in opposite direction and the vehicle will rotate about a central, vertical axis. Thus, it is possible to influence the direction of travel of the vehicle. It is also possible to provide the vehicle with a control system which is adapted for making the motor 5 drive selectively neither of the two wheels 1, 2, one of the two wheels 1, 2 or both wheels 1, 2.

According to the invention, at least one wheel 1, 2 of the vehicle is connected to a steering mechanism for controlling the direction of travel of the vehicle, which steering mechanism comprises means for adjusting the momentary distance from the axis of rotation of at least a part of one wheel 1, 2 to the ground. Thus, a direct steering of the vehicle is possible in a simple manner. The means comprise e.g. two non-shown ring-shaped and inflatable elements which are disposed on the running surface of the two wheels 1, 2. By inflating one of such elements the radius of the, relevant wheel changes, so that the direction of travel of the moving vehicle changes.

The wheels 1, 2 may be made of synthetic material and/or metal and have a diameter which depends on the function and the area of application of the vehicle. On the outer side the wheels 1, 2 may be provided with an outer disc 9 with spokes and/or apertures. It is also possible to use, instead of wheels, one or more rollers and/or one or more blade or paddle wheels.

In a further, non-shown embodiment the vehicle comprises only one motor 5 which may be fitted in one of the wheels 1, 2 or centrally to the frame 3. The single motor 5 is then capable of driving one of the two wheels 1, 2 or both wheels 1, 2. By adjusting the driving ratio between the two wheels 1, 2 it is possible to steer the vehicle.

The vehicle has an excellent manoeuvrability and can be steered accurately by means of the steering mechanism according to the invention. The vehicle. is also capable of easily surmounting small obstructions without harmful consequences. The vehicle can be remotely controlled, e.g. by means of a (non-shown) computer which is in connection with the vehicle via a transmitter and receiver unit.

As described in the foregoing, the displacement of the centre of gravity of the vehicle by means of the motor(s) 5 may take place by making a driving weight (e.g. constituted by the motor 5 with its energy supply) rotate about an axis of rotation of a wheel 1, 2, but may also take place by displacing the driving weight in another manner, for example with the aid of a (non-shown) element which is capable of sliding in and out (e.g. a telescopic element) driven by the motor(s) 5.

FIG. 4 is a schematic perspective view of a further embodiment of a vehicle according to the invention. Now a roller or cylinder 10, in which the motor and the driving weight are disposed, is used as a rotatable element. The drive works on the same principle as described in the foregoing: the driving weight is displaced by the motor in such a way that the centre of gravity of the vehicle is raised. The roller 10 is provided with a steering mechanism for influencing its direction of travel. Said steering mechanism comprises means 11 for adjusting the momentary distance from the axis of rotation of a part of the roller 10 to the ground.

In the embodiment shown said means 11 are designed as elements with a variable volume (e.g. an inflatable ring). Other, non-shown options are: an element which is capable of being folded in or out, or an element which is capable of sliding in and out (e.g. a telescopic element). For example, at one side of the roller 10 a plurality of (small) bars may radially extend outwards from the running surface, while the ends of said bars may be provided, if desired, with supporting faces for the purpose of increasing their surface. The steering mechanism according to the invention may also comprise means for adjusting the momentary coefficient of friction of at least a part of the roller 10 relative to the ground. At one side of the roller 10 the running surface may be smoothened or roughened temporarily. This may take place by means of a tread or with the aid of a coating. It is also possible to realize locally an adjustment of friction through a weight displacement inside the roller 10, by means of which it is possible to influence the rolling direction of the vehicle. Through a weight displacement inside the roller 10 it is also possible to increase or decrease the pressure on a deformable part of the roller 10 in such a manner that said part is deformed and will consequently obtain an other coefficient of friction.

The vehicle may further comprise two wheels or rollers which are interconnected by means of a fixed axis. The vehicle may be used e.g. as a pressure roller.

1. A vehicle comprising a motor (5) and at least one rotatable element (1, 2; 10) which is in contact with the ground during travelling of the vehicle, whereby at least one rotatable element (1, 2; 10) is connected to a steering mechanism for controlling the direction of travel of the vehicle, characterized in that the steering mechanism comprises means (11) for adjusting the momentary distance from the axis of rotation of at least a part of a rotatable element (1, 2; 10) to the ground.

2. A vehicle as claimed in claim 1, characterized in that the means (11) comprise an element with a variable volume.

3. A vehicle as claimed in any one of claims 1 and 2, characterized in that the means (11) comprise an element which is capable of being folded in or out, or an element which is capable of sliding in and out (e.g. a telescopic element).

4. A vehicle as claimed in any one of claims 1 to 3, characterized in that the means (11) comprise an element with a variable coefficient of friction.

5. A vehicle comprising a motor (5) and at least one rotatable element (1, 2; 10) which is in contact with the ground during travelling of the vehicle, whereby at least one rotatable element (1, 2; 10) is connected to a steering mechanism for controlling the direction of travel of the vehicle, characterized in that the steering mechanism comprises means for adjusting the momentary coefficient of friction of at least a part of a rotatable element (1, 2; 10).

6. A vehicle as claimed in any one of claims 1 to 5, characterized in that the rotatable element (1, 2; 10) is constituted by a roller (10) in which the motor (5) is disposed.

7. A vehicle as claimed in any one of claims 1 to 6, characterized in that the vehicle comprises two wheels or rollers (1, 2; 10) which are interconnected by means of a fixed axis.

8. A vehicle as claimed in any one of claims 1 to 7, characterized in that the vehicle is. provided with a driving weight (5-7) which is displaceable by means of the motor (5).

9. A vehicle as claimed in any one of claims 1 to 8, characterized in that during travelling the contact surface of the vehicle with the ground is substantially in one line which is situated in a plane extending perpendicular to the ground and through the axis of rotation of the rotatable element (1, 2; 10).
